(19) United States
(12) Patent Application Publication
(10) Pub. No.: US 2010/0138458 A1
(43) Pub. Date: Jun. 3, 2010

(54) MEDIA DATA COMPILATION METHOD AND SYSTEM

(76) Inventors: ANDREAS LILJEFELT, Marsta (SE); Leo Bergman, Asbro (SE)

Correspondence Address: HOLLAND & KNIGHT LLP, 10 ST. JAMES AVENUE, BOSTON, MA, 02116-3889, US

(21) Appl. No.: 12/626,103

(22) Filed: Nov. 25, 2009

Related U.S. Application Data
(60) Provisional application No. 61/117,669, filed on Nov. 25, 2008.

(51) Int. Cl. G06F 17/30

(52) U.S. Cl. 707/812; 707/E17.009

(57) ABSTRACT

A method, system, and computer program product includes creating a media data compilation including: one or more track variation data arrays representing one or more variations of one or more tracks of a media recording, the one or more track variation data arrays including media data for the one or more variations of one or more tracks of the media data compilation; and one or more data array pointers, the one or more data array pointers configured to identify at least one of the one or more track variation data arrays. The one or more track variation data arrays are compressed and stored in a file. The one or more data array pointers are stored in a database.

### RELATED APPLICATIONS

This application claims the benefit of U.S. Provisional Ser. No. 61/117,669 filed Nov. 25, 2008, the entire contents of which are herein incorporated by reference in its entirety.

### FIELD OF THE INVENTION

This disclosure relates to media data and, more particularly, to providing a media data compilation.

### BACKGROUND OF THE INVENTION

Media files, such as audio, video, and/or image files, are often large files containing large amounts of data. An MP3 file containing a song, for example, may be multiple megabytes. If a song is broken up into multiple audio files, each containing a separate instrumental track, each file may be multiple megabytes in size.

Transferring large amounts of media data over a network can be costly and time consuming. For example, it may be cumbersome and time consuming for a user to download all the tracks of a song if the user wants to create a new mix of the song from the separate tracks. The user may have to download individual tracks (such as guitar tracks, drum tracks, etc), and individual variations of the tracks (such as blues variations of the tracks, rock variations of the tracks, etc.). A method, system, and/or computer program product that creates a compilation of media data may provide benefits to the user.

### BRIEF SUMMARY OF THE INVENTION

In an embodiment, a method includes creating a media data compilation. The media data compilation may include one or more track variation data arrays representing one or more variations of one or more tracks of a media recording, the one or more track variation data arrays including media data for the one or more variations of one or more tracks of the media data compilation; and one or more data array pointers, the one or more data array pointers configured to identify at least one of the one or more track variation data arrays. The one or more track variation data arrays are compressed and stored in a file. The one or more data array pointers are stored in a database.

One or more of the following features may be included. The one or more data array pointers may include one or more fields identifying one or more of: a variation of an instrumental track associated with the at least one of the one or more data arrays; an artist associated with the at least one of the one or more data arrays; a song associated with the at least one of the one or more data arrays; a track number associated with the at least one of the one or more data arrays; and a section associated with the at least one of the one or more data arrays. The one or more track variation data arrays may include audio data; video data; and/or image data.

Compressing the one or more track variation data arrays may include converting at least one of the one or more track variation data arrays to ActionScript Message Format (AMF) byte code data containers. Creating the media data compilation and compressing the one or more track variation data arrays may include executing one or more ActionScript scripts configured to create the media data compilation and/or compress at least one of the one or more track variation data arrays.

At least one of the one or more track variation data arrays may include data representing a single instrumental track recorded in a predefined musical variation. The media data compilation may represent a section of a media recording. Compressing the one or more track variation data arrays may include converting the media data of at least one of the one or more track variation data arrays to lower resolution media data.

In another embodiment, a computer program product resides on a computer readable storage medium. The computer program product includes a plurality of instructions, which, when executed by a processor, cause the processor to perform operations including creating a media data compilation. The media data compilation may include one or more track variation data arrays representing one or more variations of one or more tracks of a media recording, the one or more track variation data arrays including media data for the one or more variations of one or more tracks of the media data compilation; and one or more data array pointers, the one or more data array pointers configured to identify at least one of the one or more track variation data arrays. The one or more track variation data arrays are compressed and stored in a file. The one or more data array pointers are stored in a database.

One or more of the following features may be included. The one or more data array pointers may include one or more fields identifying one or more of: a variation of an instrumental track associated with the at least one of the one or more data arrays; an artist associated with the at least one of the one or more data arrays; a song associated with the at least one of the one or more data arrays; a track number associated with the at least one of the one or more data arrays; and a section associated with the at least one of the one or more data arrays. The one or more track variation data arrays may include audio data; video data; and/or image data.

Compressing the one or more track variation data arrays may include converting at least one of the one or more track variation data arrays to ActionScript Message Format (AMF) byte code data containers. Creating the media data compilation and compressing the one or more track variation data arrays may include executing one or more ActionScript scripts configured to create the media data compilation and/or compress at least one of the one or more track variation data arrays.

At least one of the one or more track variation data arrays may include data representing a single instrumental track recorded in a predefined musical variation. The media data compilation may represent a section of a media recording. Compressing the one or more track variation data arrays may include converting the media data of at least one of the one or more track variation data arrays to lower resolution media data.

In another embodiment, a system includes a processor, a memory coupled to the processor, and a plurality of instructions stored in the memory. The plurality of instructions, when executed by the processor, cause the processor to perform operations including creating a media data compilation. The media data compilation may include one or more track variation data arrays representing one or more variations of one or more tracks of a media recording, the one or more track variation data arrays including media data for the one or more variations of one or more tracks of the media data compilation; and one or more data array pointers, the one or more data array pointers configured to identify at least one of the one or more track variation data arrays. The one or more track variation data arrays are compressed and stored in a file. The one or more data array pointers are stored in a database.

One or more of the following features may be included. The one or more data array pointers may include one or more fields identifying one or more of: a variation of an instrumental track associated with the at least one of the one or more data arrays; an artist associated with the at least one of the one or more data arrays; a song associated with the at least one of the one or more data arrays; a track number associated with the at least one of the one or more data arrays; and a section associated with the at least one of the one or more data arrays. The one or more track variation data arrays may include audio data; video data; and/or image data.

Compressing the one or more track variation data arrays may include converting at least one of the one or more track variation data arrays to ActionScript Message Format (AMF) byte code data containers. Creating the media data compilation and compressing the one or more track variation data arrays may include executing one or more ActionScript scripts configured to create the media data compilation and/or compress at least one of the one or more track variation data arrays.

At least one of the one or more track variation data arrays may include data representing a single instrumental track recorded in a predefined musical variation. The media data compilation may represent a section of a media recording. Compressing the one or more track variation data arrays may include converting the media data of at least one of the one or more track variation data arrays to lower resolution media data.

### BRIEF DESCRIPTION OF THE SEVERAL VIEWS OF THE DRAWINGS

FIG. 1 is diagrammatic view of a computing infrastructure.

FIG. 2 is a block diagram of a computing device.

FIG. 3 is a flowchart diagram of a media process.

FIG. 4 is a diagrammatic view of a media data compilation.

Like figures in the drawings may denote like elements.

### DETAILED DESCRIPTION OF THE INVENTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in one or more computer-readable (i.e., computer-usable) medium(s) having computer-usable program code embodied thereon.

Any combination of one or more computer-readable medium(s) may be utilized. The computer-readable medium may be a computer readable signal medium or a computer readable storage medium. A computer-readable storage medium may be, for example, but not limited to, an electronic, magnetic, optical, electromagnetic, infrared, or semiconductor system, apparatus, a device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any medium that can contain, or store a program for use by or in connection with an instruction execution system, apparatus, or device.

A computer readable signal medium may include a propagated data signal with computer-usable program code embodied therein, for example, in baseband or as part of a carrier wave. Such a propagated signal may take any of a variety of forms, including, but not limited to, electro-magnetic, optical, or any suitable combination thereof, A computer readable signal medium may be any computer-readable medium that can contain, store, communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. Computer program code for carrying out operations of the present invention may also be written in a scripting language, such as the JavaScript™ language, the ActionScript language, or similar scripting languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

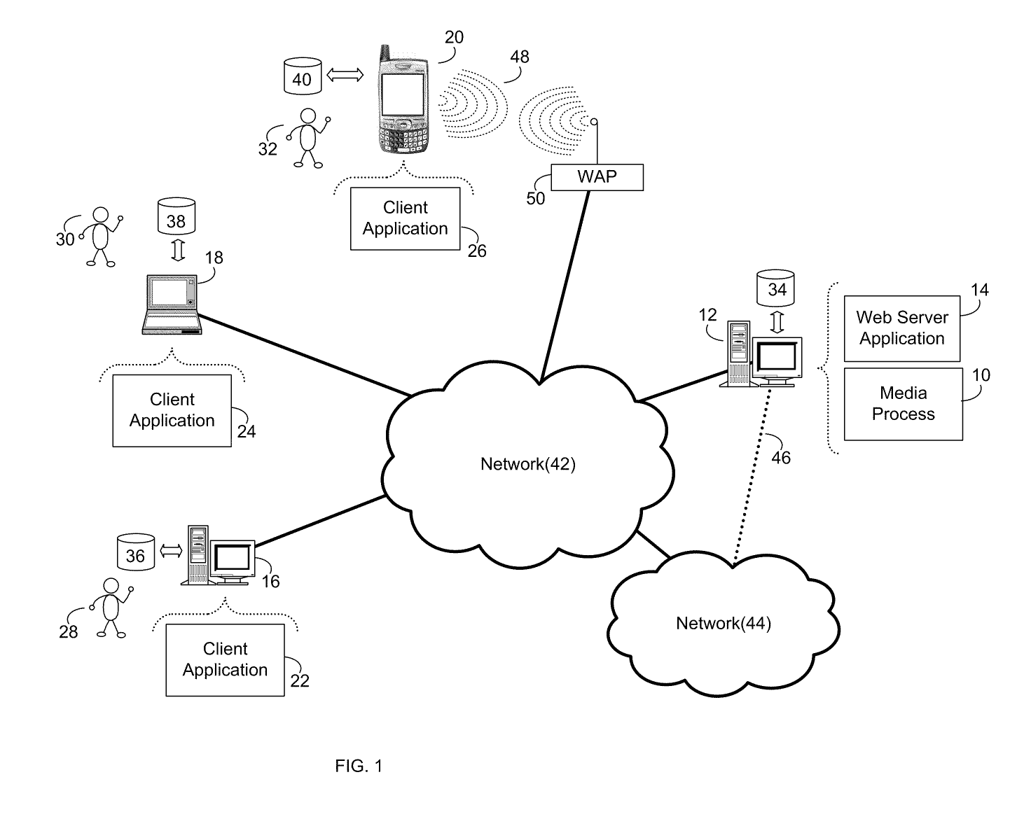

FIG. 1 depicts a computing infrastructure within which media process 10 may reside. Media process 10, for example, may reside on and may be executed by server 12, which may be a server computer. Server 12 may also execute web server application 14. Web server application 14 may be an application that serves and/or provides access to a website, for example. Examples of web server application 14 may include, but are not limited to: the Microsoft™ Internet Information Services and the Apache™ webserver. Web server application 14 may serve webpages, and may also support scripts such as ASP scripts, ActionScript (AS) scripts, JavaScript scripts, .NET scripts, and the like. Server 12 may also execute a network operating system, examples of which include, but are not limited to: Microsoft Windows NT, Novell Netware, Unix, Linux, etc.

Computer 16, laptop 18, and PDA 20 may be end user devices. Server 12, computer 16, laptop 18, and PDA 20 may run network operating systems, examples of which may include but are not limited to: Microsoft Windows XP™; Novell Netware™; or Redhat Linux™, for example. Computer 16, laptop 18, and PDA 20 may also execute client applications 22, 24, 26, respectively. Client applications 22, 24, 26 may be applications such as web browser that allows users 28, 30, 32 to access data and media provided by server 12 and/or web server application 14, for example. Client applications 22, 24, 26 may also be any other type of application that allows users 28, 30, 32 to access data and media provided by server 12 and/or web server application 14. For example, client applications 22, 24, 26 may be a custom application that allows users 28, 30, 32 to access data and media provided by server 12 and/or web server application 14.

As will be discussed below in greater detail, media process 10 may create a media data compilation. The media data compilation may include one or more track variation data arrays that may represent one or more variations of one or more tracks of a media recording. The one or more track variation data arrays may include media data for the one or more variations of one or more tracks of the media data compilation. The media data compilation may also include one or more data array pointers, which may be configured to identify at least one of the one or more track variation data arrays.

Media process 10 may be executed in whole or in part by server 12. Media process 10 may also be executed in whole or in part by computer 16, laptop 18, and/or PDA 20. The instruction sets and subroutines of media process 10, which may include one or more software modules and one or more sets of software instructions, may be stored in whole or in part on storage device 34 coupled to server 12, storage device 36 coupled to computer 16, storage device 38 coupled to laptop 18, and/or storage device 40 coupled to PDA 20. Media process 10 may be executed by one or more processors and one or more memory architectures incorporated into the various electronic devices. Storage devices 34, 36, 38, 40 may include but are not limited to: hard disk drives; solid state drives; tape drives; optical drives; RAID arrays; random access memory (RAM); and a read-only memory (ROM).

The instruction sets and subroutines of media process 10 may be generated through the use of a compiler, such as the IBM XL compiler, the Visual Studio® compiler, or an assembler, for example. The instruction set and subroutines may also be generated as scripts, such as JavaScript scripts, AS3 scripts, or as other types of software code. In general, and as is known in the art, the instruction sets and subroutines of media process 10 may be generated via any method of generating instruction sets and subroutines that may be executed by a processor.

The various client electronic devices (e.g. server 12, computer 14, laptop 16, and/or PDA 20) may be coupled to network 42. Examples of client electronic devices may include, but are not limited to: server 12, computer 14, laptop 18, PDA 20, a data-enabled, cellular telephone (not shown), a game console (not shown), and a dedicated network device (not shown). One or more users (e.g., users 28, 30, 32) may access the various tools and applications, such as media process 10 and web server application 14, from any device connected to network 42 or directly from the device on which the tool or application resides.

Various computer devices and/or client electronic devices may be coupled directly to network 42, or may be indirectly coupled to network 42, e.g. through network 44. For example, server 12 may be indirectly connect to network 42 through secondary network 44, as illustrated by phantom link line 46.

The various client electronic devices may be directly, indirectly, and/or wireless sly coupled to network 42 (or network 44). For example, server 12, computer 14, and laptop 18 are shown directly coupled to network 42 via a hardwired network connections. PDA 20 is shown wirelessly coupled to network 42 via wireless communication channel 48 established between laptop 18 and wireless access point (i.e., WAP) 50, which is shown directly coupled to network 42. WAP 50 may be, for example, an IEEE 802.11a, 802.11b, 802.11g, Wi-Fi, and/or Bluetooth device that is capable of establishing wireless communication channel 48 between PDA 20 and WAP 50.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

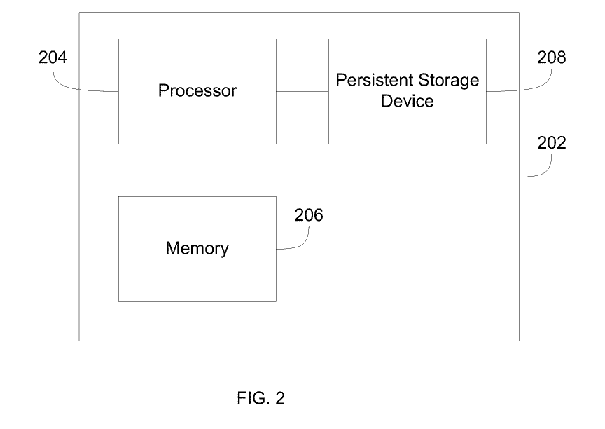

FIG. 2 shows an example of a computing device architecture that may be used to execute media process 10. Computing device 202 may include processor 204. Processor 204 may be a computer processor, or a series of computer processors. Examples of processor 204 may include, but are not limited to: a general purpose processor, a custom processor, a microprocessor, etc. Processor 204 may be a central processing unit (CPU), or may be an ancillary or special purpose processor, such as a video processor, north bridge processor, etc. Computing device 202 may also include memory 206, which may be coupled to processor 204. Memory 206 may be a computer readable storage device that may hold computer program instructions. Examples of memory 206 include, but are not limited to: a random-access memory (RAM), a read-only memory (ROM), a flash memory, etc. Computing device 202 may also include persistent storage device 208, coupled (directly or indirectly) to processor 204. Persistent storage device 208 may also be a computer readable storage device, which may provide persistent data storage to computing device 202, for example. Examples of persistent storage device 208 include, but are not limited to: a hard drive, a CD, a DVD, a USB drive, a flash drive, a Blue Ray disk, and the like.

The instruction sets and subroutines of media process 10 may be stored in a computer readable storage device, such as memory 206 and/or persistent storage device 208. Processor 204 may load and execute the instructions and subroutines of media process 10 stored on memory 206 and/or persistent storage device 208.

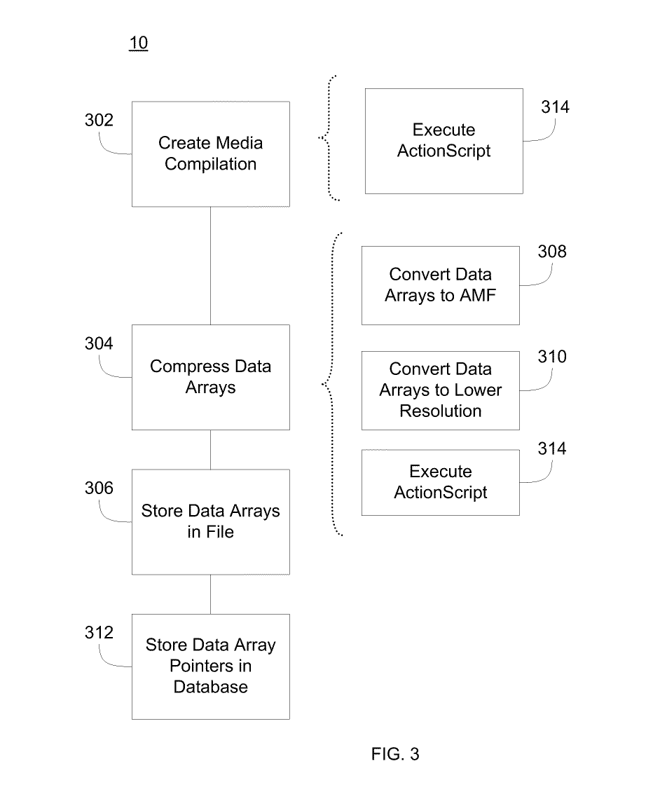

Referring also to FIG. 3, the instructions and subroutines of media process 10 may cause processor 204 and/or computing device 202 to perform operations, including creating 302 a media data compilation. The media data compilation may include one or more track variation data arrays that may represent one or more variations of one or more tracks of a media recording. The one or more track variation data arrays may include media data for the one or more variations of one or more tracks of the media data compilation. The media data compilation may also include one or more data array pointers, which may be configured to identify at least one of the one or more track variation data arrays.

A media data compilation may include one or more files containing media data for a media recording. A media recording may be any type of media recording including audio (e.g. MP3, WAV, egc.), video (e.g. MPEG, WMV, etc), and/or image (e.g. JPG, GIF, BMP, etc). The media data compilation may also include one or more track variation data arrays. A track variation data array may be an array or collection of data representing at least a portion of the media recording. For example, if the media recording is audio, the media recording may be separated into tracks representing a portion of the media recording. A track may include data for a single instrument, a group of instruments, a vocal recording, etc. The various tracks, each representing at least a portion of the audio recording, may produce the full audio recording when mixed together.

A track variation data array may include data representing a single track of a media recording recorded in a predefined musical variation. For example, a track variation data array may include data representing a variation of a track. Assume, for instance, that a media data compilation has three tracks: guitar, drums, and keyboard. The media data compilation may include track variation data arrays that may include media data for variations of the guitar, drums, and keyboard tracks. The media data in the track variation data arrays may represent different musical styles or variations of the same media. For example, if the media data compilation is a song, and a track represents the guitar portion of the song, the track variation data arrays may include tracks of different styles for the song, such as rock guitar, jazz guitar, and/or country guitar. For example, if the media recording is a recording of the song “Blue Suede Shoes” by Elvis Presley, the media data compilation may include a blues guitar variation, a jazz guitar variation, and/or country guitar variation of the guitar track of “Blue Suede Shoes.” Of course, the media data compilation may also include media data for different styles of drums, bass guitar, keyboard, vocals, and/or any other track for the song “Blue Suede Shoes.”

The media data compilation file may represent a section of a media recording. A section of a media recording may be the entire media recording, or may be a portion of a media recording such as, in the context of a musical recording, the introduction, bridge, chorus, etc. Additionally/alternatively, the media data compilation may represent the entirety of the song. Accordingly, if the media data compilation represents a section of a song (such as the introduction), the track variation data arrays may also represent the section of the song (e.g. the introduction); if the media data compilation represents the entirety of a song, the track variation data arrays may also represent the entirety of the song.

Media process 10 may create 302 the media data compilation by reading a folder containing media recordings. For example, a folder may contain audio recordings representing variations of tracks of a song. The audio recordings may be MP3 files, WMA files, or any other type of audio format. The audio recordings may be identified by artist, song, section of the song, track of the song, and variation of the track of the song. In one example, the audio recordings may be files with file names corresponding to the following format: artistID-songID-sectionIndex-trackIndex-variationIndex.MP3. The sections of the format (i.e. artistID, songID, sectionIndex, trackIndex, and variationIndex) may be text, integers, floating point numbers, GUIDs, or any other type of data that may be used to identify the artist, song, section, track, and variation of the media recording. Media process 10 may then read the folder and, for one or more songs, create 302 a media data compilation that includes the audio recordings associated with the song. The media process 10 creates 302 the media data compilation, the data from the media recordings may be captured in one or more track variation data arrays within the media data compilation.

The media data compilation may also include one or more data array pointers, which may be configured to identify at least one of the one or more track variation data arrays. A data array pointer may be used to identify a particular track variation data array within a media data compilation. For example, assume an audio recording contains the guitar track for “Blue Suede Shoes” recorded in a jazz variation. Also assume that media process 10 creates 302 a media data compilation that includes the audio recording. For example, one of the track variation data arrays may contain the guitar track for “Blue Suede Shoes” recorded in the jazz variation. Also, the other track variation data arrays may contain various other tracks recorded in various other variations. Media process 10 may create 302 the media data compilation with one or more data array pointers. The data array pointers may be configured to identify the track variation data arrays within the media data compilation.

Continuing the example, one of the data array pointers may be configured to identify the guitar track for “Blue Suede Shoes” recorded in the jazz variation. The data array pointer may include information that identifies the song (Blue Suede Shoes), the artist (Elvis Presley), the track (e.g. guitar), the section (e.g. introduction, chorus, etc.), and/or the variation (e.g. jazz). As an example, the data array pointer may have a format similar to the following: d1-d2-d3-d4-d5. In this example, d1 may correspond to data identifying the song, d2 may correspond to data identifying the artist, d3 may correspond to data identifying the track, d4 may correspond to data identifying the section, and d5 may correspond to data identifying the variation. One skilled in the art will understand that d1-d5 may be integers, text, floating point numbers, or any other type of data used to identify the song, artist, track, section, and/or variation. One skilled in the art will also recognize that the information incorporated in the data array pointer (e.g. d1-d5) may be in any order, and may be in any form (e.g. a bitmap, a hash, a series of bytes, etc).

The example above describes a data array pointer with five fields or elements of information (e.g. d1-d5). However, a data array pointer may include more than five or fewer than five fields or elements of information. In general, a data array pointer may include enough fields and/or information necessary to identify a track variation data array in the media data compilation. The data array pointer may include one or more fields that identify one or more of: a variation of a track associated with a track variation data array (e.g. guitar, drums, vocal, etc), an artist associated with a track variation data array (e.g. Elvis Presley, the B52's, etc), a song associated with a track variation data array (e.g. Blue Suede Shoes, Rock Lobster, etc), a track number associated with a track variation data array, and/or a section associated with a track variation data array (e.g. introduction, chorus, etc). The data array pointer may also include any other type of data associated with a track variation data array that may be used, for example, to identify the track variation data array.

Media process 10 may also compress 304 the one or more track variation data arrays. Media process 10 may compress 304 the track variation data arrays individually, or may compress 304 one or more track variation data arrays collectively. Media process 10 may also store 306 the one or more track variation data arrays in a file. Compressing 304 the track variation data arrays and storing 306 the track variation data arrays in a file may obfuscate the media data and make it difficult to extract the media data from the media data compilation. For example, compressing 304 the track variation data arrays may include converting 308 at least one of the one or more track variation data arrays to an ActionScript Message Format (AMF) bytecode data container. An AMF format utilizing AMF bytecode data containers may reduce the number of bytes used by the media data. If the media data within the track variation data arrays was originally MP3 data, converting 308 the track variation data arrays to AMF may reduce the size and/or the number of bytes stored in the track variation data arrays. Compressing 304 the track variation data arrays may also include applying a compression algorithm to one or more of the variation track data arrays. For example, media process 10 may apply a compression algorithm, including, but not limited to ZLIB/LZW, ZIP, and GZIP, to the track variation data arrays, thus compressing 304 the track variation data arrays so they have a smaller size and/or contain fewer bytes.

Compressing 304 the track variation data arrays may also include removing some or all of the header information from the media data. For example, an MP3 file may have header information that identifies information about the MP3 file. The information may include information about the track, album, artist, genre, etc. Media process 10 may remove the MP3 header information when media process 10 compresses 304 the track variation data arrays, thus reducing the size and/or the number of bytes in the track variation data arrays and/or making it difficult to identify and/or extract the media data from the track variation data arrays.

Compressing 304 the track variation data arrays may also include converting 310 the media data of at least one of the one or more track variation data arrays to a lower resolution media data. For example, if the media data contained in the original media and/or the track variation data arrays has a high bitrate, media process 10 may convert 304 the media data to a lower resolution. If, for example, the media data is MP3 audio data with a bitrate of 128 kbps, media process 10 may convert 310 the MP3 audio data to a lower bitrate, such as 64 kbps. Converting 304 the media data to a lower resolution may reduce the size and/or number of bytes in the track variation data arrays. One skilled in the art will recognize that media process 10 may also convert 310 video and image data to lower resolution media data. For example, media process 10 may convert 310 video and image data by reducing the resolution of video and/or image data, and by reducing the frame rate of video data, for example.

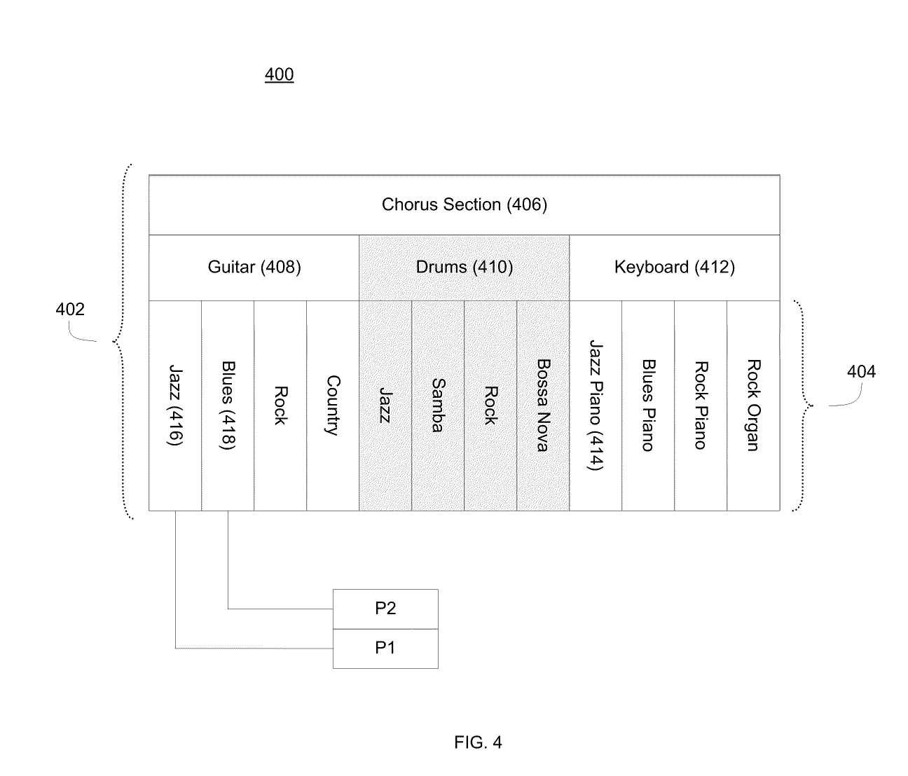

As mentioned, media process 10 may store 306 the track variation data arrays in a file. The file may contain, for example, the media data contained in the track variation data arrays. FIG. 4 shows an example of a media data compilation (e.g. media data compilation 400), including file 402 and data array pointers P1, P2. File 402 may contain track variation data arrays 404 which may be variations of tracks of a section of a song. As shown by box 406, file 402 may represent the chorus section of a song. Of course, file 402 may also represent other sections of a song, including the introduction, bridge, the verses of the song, etc. Also as shown in FIG. 4, track variation data arrays 404 may represent guitar, drum, and keyboard tracks of the song, as shown by boxes 408, 410, 412. Track variation data arrays 404 may also represent various variations of the tracks. For example, track variation data array 414 may be a jazz piano variation of the keyboard track of the chorus section of the song. Boxes 406, 408, 410, 412, and track variation data arrays 404 may be shown for illustrative purposes, and are not intended to be restrictive of the format of file 402. For example, file 402 may be arranged in a different format that contains the media data of track variation data arrays 404.

File 402 may be a single file or a series of files. File 402 may be stored on a storage device, such as a hard drive or memory, or may be stored in a database. File 402 may also be uploaded and/or downloaded over a network. Uploading and/or downloading file 402 may include uploading and/or downloading all or a portion of track variation data arrays 404.

Media process 10 may also store 312 the one or more data array pointers in a database. FIG. 4 shows data array pointers P1, P2. As discussed above, data array pointers P1, P2 may be configured to identify one or more track variation data arrays 404 in file 402. For example, data array pointer P1 may be configured to identify track variation data array 416, which may represent a jazz variation of a guitar track of a chorus section of a song. Data array pointer P2 may be configured to identify track variation data array 418 which may represent a blues variation of a guitar track of the chorus section of the song. Other data array pointers (not shown) may also be configured to identify various other track variation data arrays 404 in file 402.

The information contained in pointers P1, P2 (e.g. information about section, track, variation, etc) may be stored in a single field in a database, or multiple fields in a database. Additionally/alternatively, the information contained in pointers P1, P2 may be stored in one database, multiple databases, or various sections of one or more databases. The database may be any type of data including, but not limited to, a relational database, an XML file, a flat file, a series of files, and the like. In one example, media process 10 may store 312 data array pointers P1, P2 in a database separate from file 402. In another example, media process 10 may store 312 data array pointers P1, P2 in the same database (and/or the same file) as file 402.

Media process 10 may create 302 the media data compilation and/or compress 304 the one or more track variation data arrays by executing 314 one or more ActionScript scripts configured to create 302 the media data compilation and/or compress 304 at least one of the one or more track variation data arrays. An ActionScript script may be a script written in the ActionScript scripting language, which may be used for developing websites and software applications that utilize the Adobe Flash Player™. However, ActionScript scripts may also be used for websites and software applications that do not use the Adobe Flash Player.

The methods, computer program products, and systems claimed may be used, for example, to provide audio, video, and/or image data to a user over a network. In one example, the user may wish to mix a song or a section of a song by choosing from and mixing variations of tracks of a section of a song. Media process 10 may provide file 402 to the user, and may identify track variation data arrays 404 within file 402 via data array pointer (e.g. data array pointers P1, P2). The user may then be able to create a mixed song from track variation data arrays 404. In one example, media process 10 may provide file 402 and/or pointers P1, P2 via web server application 14, and/or the user may be able to create the mixed song by accessing a website via client application 26, for example.

A number of implementations have been described. Nevertheless, it will be understood that various modifications may be made. Accordingly, other implementations and other uses are within the scope of the following claims.

What is claimed is:

1. A method comprising:
creating a media data compilation comprising:
one or more track variation data arrays representing one or more variations of one or more tracks of a media recording, the one or more track variation data arrays including media data for the one or more variations of one or more tracks of the media data compilation; and
one or more data array pointers, the one or more data array pointers configured to identify at least one of the one or more track variation data arrays;
compressing the one or more track variation data arrays;
storing the one or more track variation data arrays in a file; and
storing the one or more data array pointers in a database.

2. The method of claim 1 wherein the one or more data array pointers include one or more fields identifying one or more of:
a variation of an instrumental track associated with the at least one of the one or more data arrays;
an artist associated with the at least one of the one or more data arrays;
a song associated with the at least one of the one or more data arrays;
a track number associated with the at least one of the one or more data arrays; and
a section associated with the at least one of the one or more data arrays.

3. The method of claim 1 wherein compressing the one or more track variation data arrays comprises converting at least one of the one or more track variation data arrays to ActionScript Message Format (AMF) byte code data containers.

4. The method of claim 1 wherein the one or more track variation data arrays comprise one or more of:
audio data;
video data; and
image data.

5. The method of claim 1 wherein:
creating the media data compilation comprises executing one or more ActionScript scripts configured to create the media data compilation; and
compressing the one or more track variation data arrays comprises executing one or more ActionScript scripts configured to compress at least one of the one or more track variation data arrays.

6. The method of claim 1 wherein at least one of the one or more track variation data arrays includes data representing a single instrumental track recorded in a predefined musical variation.

7. The method of claim 1 wherein the media data compilation represents a section of a media recording.

8. The method of claim 1 wherein compressing the one or more track variation data arrays comprises converting the media data of at least one of the one or more track variation data arrays to lower resolution media data.

9. A computer program product, residing on a computer readable storage medium, having a plurality of instructions stored thereon, which, when executed by a processor, cause the processor to perform operations comprising:
creating a media data compilation comprising:
one or more track variation data arrays representing one or more variations of one or more tracks of a media recording, the one or more track variation data arrays including media data for the one or more variations of one or more tracks of the media data compilation; and
one or more data array pointers, the one or more data array pointers configured to identify at least one of the one or more track variation data arrays;
compressing the one or more track variation data arrays;
storing the one or more track variation data arrays in a file; and
storing the one or more data array pointers in a database.

10. The computer program product of claim 9 wherein the one or more data array pointers include one or more fields identifying one or more of:
a variation of an instrumental track associated with the at least one of the one or more data arrays;
an artist associated with the at least one of the one or more data arrays;
a song associated with the at least one of the one or more data arrays;
a track number associated with the at least one of the one or more data arrays; and
a section associated with the at least one of the one or more data arrays.

11. The computer program product of claim 9 wherein compressing the one or more track variation data arrays comprises converting at least one of the one or more track variation data arrays to ActionScript Message Format (AMF) byte code data containers.

12. The computer program product of claim 9 wherein the one or more track variation data arrays comprise one or more of:
audio data;
video data; and
image data.

13. The computer program product of claim 9 wherein:
creating the media data compilation comprises executing one or more ActionScript scripts configured to create the media data compilation; and
compressing the one or more track variation data arrays comprises executing one or more ActionScript scripts configured to compress at least one of the one or more track variation data arrays.

14. The computer program product of claim 9 wherein at least one of the one or more track variation data arrays includes data representing a single instrumental track recorded in a predefined musical variation.

15. The computer program product of claim 9 wherein the media data compilation represents a section of a media recording.

16. The computer program product of claim 9 wherein compressing the one or more track variation data arrays comprises converting the media data of at least one of the one or more track variation data arrays to lower resolution media data.

17. A system comprising:
a processor;
a memory coupled to the processor; and
a plurality of instructions stored in the memory, which, when executed by the processor, cause the processor to perform operations comprising:
creating a media data compilation comprising:
one or more track variation data arrays representing one or more variations of one or more tracks of a media recording, the one or more track variation data arrays including media data for the one or more variations of one or more tracks of the media data compilation; and
one or more data array pointers, the one or more data array pointers configured to identify at least one of the one or more track variation data arrays;
compressing the one or more track variation data arrays;
storing the one or more track variation data arrays in a file; and
storing the one or more data array pointers in a database.

18. The system of claim 17 wherein the one or more data array pointers include one or more fields identifying one or more of:
a variation of an instrumental track associated with the at least one of the one or more data arrays;
an artist associated with the at least one of the one or more data arrays;
a song associated with the at least one of the one or more data arrays;
a track number associated with the at least one of the one or more data arrays; and
a section associated with the at least one of the one or more data arrays.

19. The system of claim 17 wherein compressing the one or more track variation data arrays comprises converting at least one of the one or more track variation data arrays to ActionScript Message Format (AMF) byte code data containers.

20. The system of claim 17 wherein the one or more track variation data arrays comprise one or more of:
audio data;
video data; and
image data.

21. The system of claim 17 wherein:
creating the media data compilation comprises executing one or more ActionScript scripts configured to create the media data compilation; and
compressing the one or more track variation data arrays comprises executing one or more ActionScript scripts configured to compress at least one of the one or more track variation data arrays.

22. The system of claim 17 wherein at least one of the one or more track variation data arrays includes data representing a single instrumental track recorded in a predefined musical variation.

23. The system of claim 17 wherein the media data compilation represents a section of a media recording.

24. The system of claim 17 wherein compressing the one or more track variation data arrays comprises converting the media data of at least one of the one or more track variation data arrays to lower resolution media data.
